(19) United States
(12) Patent Application Publication
(10) Pub. No.: US 2024/0200525 A1
(43) Pub. Date: Jun. 20, 2024

(54) IMITATED PIRATE SHIP TYPE HYDROELECTRIC POWER GENERATION DEVICE

(71) Applicant: Shih-Hsiung CHEN, Tainan City (TW)

(72) Inventor: Shih-Hsiung CHEN, Tainan City (TW)

(21) Appl. No.: 18/519,400

(22) Filed: Nov. 27, 2023

(30) Foreign Application Priority Data
Dec. 14, 2022 (TW) 111147960

(51) Int. Cl. F03B 13/00; H02K 7/116; H02K 7/18

(52) U.S. Cl. CPC F03B 13/00; H02K 7/116; H02K 7/1823; F05B 2220/706

(57) ABSTRACT

An imitated pirate ship type hydroelectric power generation device includes a long box body (10) having an accommodating cavity (11) filled with a working fluid (WF), a hydro-turbine power generator unit (20) having an impeller (22) installed in the accommodating cavity (11) and a power generator (21) connected to the impeller (22), a pivot structure (30) installed at the top and situated in the middle of long box body (10), and a connecting structure (40) for connecting the pivot structure (30) and the long box body (10). After a force is applied to the long box body (10), the long box body (10) swings pivotally by the pivot structure (30) as the rotation center and the working fluid (WF) flows reciprocally in the accommodating cavity (11) and drive the impeller (22) to rotate to generate electric power from the power generator (21).

### TECHNICAL FIELD

The present disclosure relates to a hydroelectric power generation device, and more particularly relates to an imitated pirate ship type hydroelectric power generation device.

### RELATED ART

Due to the increasingly higher record of global temperatures and the lower level of oil reserves, renewable energy sources with relatively less environmental impacts and utilizing the inexhaustible nature of natural resources such as solar power, wind power, hydropower and marine current power have flourished and become a hot topic in research.

Although solar power and wind power can generate electricity, they are subject to the influence of weather and unable to generate electricity in a stable and continuous manner. As to the solar power generation, the thermal and photovoltaic conversion efficiencies cannot be effectively enhanced, resulting in a very limited output of electricity. As to wind power generation, the limitation by wind farms, the difficulty of installation and high noise generated during operation are problems that need to be overcome.

In view of the above, the present discloser based on years of experience to conduct extensive research and experiment, and finally provided a hydroelectric power generation device of this disclosure to improve the drawbacks of the related art.

### SUMMARY OF THE DISCLOSURE

The objective of the present disclosure is to provide an imitated pirate ship type hydroelectric power generation device, which is not subject to weather or geographic limitations and thus is capable of generating electricity continuously and uninterruptedly.

To achieve the aforementioned objective, the present disclosure provides an imitated pirate ship type hydroelectric power generation device filled with a working fluid. The imitated pirate ship type hydroelectric power generation device includes a long box body, a hydro-turbine power generator unit, a pivot structure and a connecting structure. The long box body has an accommodating cavity for filling the working fluid, and the hydro-turbine power generator includes an impeller installed in the accommodating cavity and a power generator connected to the impeller. The pivot structure is installed at the top and situated in the middle of the long box body. The connecting structure is connected to the pivot structure and the long box body. After a force is applied to the long box body, the long box body swings pivotally by the pivot structure as the rotation center, and the working fluid flows reciprocally in the accommodating cavity and drives the impeller to rotate to generate electric power from the power generator.

The present disclosure further has the following advantages:

1. It is possible to swing (or oscillate) the long box body with a small force, to drive the impeller by means of the working fluid, and to generate electricity by means of the power generator.

2. A part of the electric power generated by the power generator is supplied to the drive and control structure for driving the long box body to swing, and another part of the electric power is used as a supply of external electric power, resulting in an overall net output for sustainable power generation.

3. The device of the present disclosure may be set anywhere on land, lake, ocean, etc.

4. The device of the present disclosure is a renewable energy device that combines the concepts of torque, centrifugal force and inertial force with hydroelectric power generation, and may be used to generate electricity 24 hours a day without being affected by the weather.

5. The controller adjusts the related parameters such as the rotating direction and speed of the electric motor to generate power according to actual requirements and to meet the peak or off-peak demand for electric power consumption.

6. With the installation of the power storage device, the electric power generated by the power generator may be stored for future use or for special need at other time of the day, especially for the off-grid period.

7. The long box body may swing with a simple structure and a little force.

8. The pivot structure carries all or most of the main weight, so that it does not require a lot of force for the long box body to produce oscillation, even when the long box body is tilted to one side.

### BRIEF DESCRIPTION OF THE DRAWINGS

FIG. 1 is a cross-sectional view showing the assembly of an imitated pirate ship type hydroelectric power generation device of the present disclosure;

FIG. 2 is a first cross-sectional view showing a using status of an imitated pirate ship type hydroelectric power generation device of the present disclosure;

FIG. 3 is a second cross-sectional view showing a using status of an imitated pirate ship type hydroelectric power generation device of the present disclosure;

FIG. 4 is a block diagram of a power transmission system of the present disclosure; and

FIG. 5 is a cross-sectional view showing an assembly of another embodiment of the present disclosure.

### DETAILED DESCRIPTION

The technical characteristics of this disclosure will become apparent with the detailed description of preferred embodiments accompanied with the illustration of related drawings as follows. It is noteworthy that the embodiments and drawings disclosed herein are to be considered illustrative rather than restrictive.

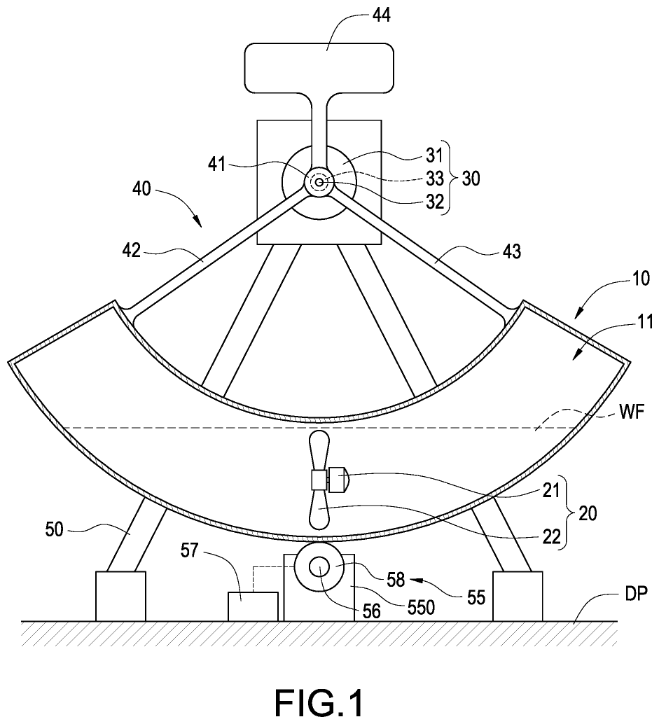

With reference to FIG. 1 for an imitated pirate ship type hydroelectric power generation device of the present disclosure, the hydroelectric power generation device includes a long box body 10, a hydro-turbine power generator unit 20, a pivot structure 30 and a connecting structure 40.

In an embodiment of the present disclosure, the long box body 10 is fan shaped, but it is not limited to this shape only, it may also be in the shape of a ship or any other elongated shape. The long box body 10 has a rectangular or circular cross-section or a cross-section in any other geometric shape, and the long box body 10 includes an accommodating cavity 11, and a working fluid WF filled in the accommodating cavity 11.

The hydro-turbine power generator unit 20 mainly includes a power generator 21 and an impeller 22 connected to the power generator 21 and installed in the accommodating cavity 11, and the water flowing direction is the same as the rotating direction. The hydro-turbine power generator unit 20 may be, but not limited to, a Wells turbine or an impulse turbine, so as to drive the power generator 21 to generate power by the rotation of the impeller 22.

The pivot structure 30 is installed at the top of the long box body 10 and disposed in the middle of the long box body 10. The pivot structure 30 mainly includes a shaft seat 31, a shaft 32 and a bearing 33, and the shaft 32 is connected to the shaft seat 31 through the bearing 33.

In this embodiment of the present disclosure, the connecting structure 40 includes a bushing 41 and a first link rod 42 and a second link rod 43, which are connected to the bushing 41. The bushing 41 is connected to the shaft 32, another end of the first link rod 42 is connected to an end of the long box body 10, and another end of the second link rod 43 is connected to another end of the long box body 10.

In an embodiment of the present disclosure, the connecting structure 40 further includes a balance member 44 connected to the bushing 41 and extended in a direction opposite to the first link rod 42 and the second link rod 43, and provided for counter mass to make the oscillation of the long box body 10 easier.

In an embodiment of the present disclosure, the imitated pirate ship type hydroelectric power generation device further includes a support structure 50 with an end fixed to a lower platform DP and another end provided for fixing the pivot structure 30.

In an embodiment of the present disclosure, the imitated pirate ship type hydroelectric power generation device further includes a drive and control structure 55 installed at the bottom of the long box body 10 and slidably contacting the long box body 10. The drive and control structure 55 mainly includes a fixed base 550, an electric motor 56, a controller 57 electrically connected to the electric motor 56, and a roller 58 connected to the electric motor 56. The fixed base 550 is disposed at the top of the lower platform DP, and the electric motor 56 and the roller 58 are installed on the fixed base 550. The electric motor 56 drives the long box body 10 to swing through the roller 58, and the controller 57 is provided for changing the rotation direction and speed of the electric motor 56. The roller 58 is a rubber wheel or a gear capable of making the long box body 10 rotate along the contact surface of the roller 58 and operate by rubbing the bottom of the long box body 10, or produce a deceleration or braking effect on the long box body 10 when the roller 58 is driven by the electric motor 56 to rotate counterclockwise.

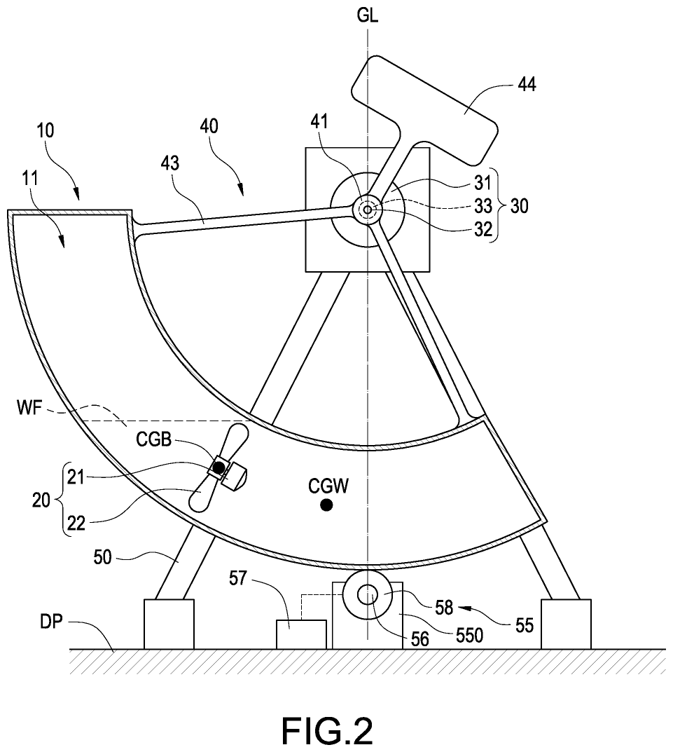

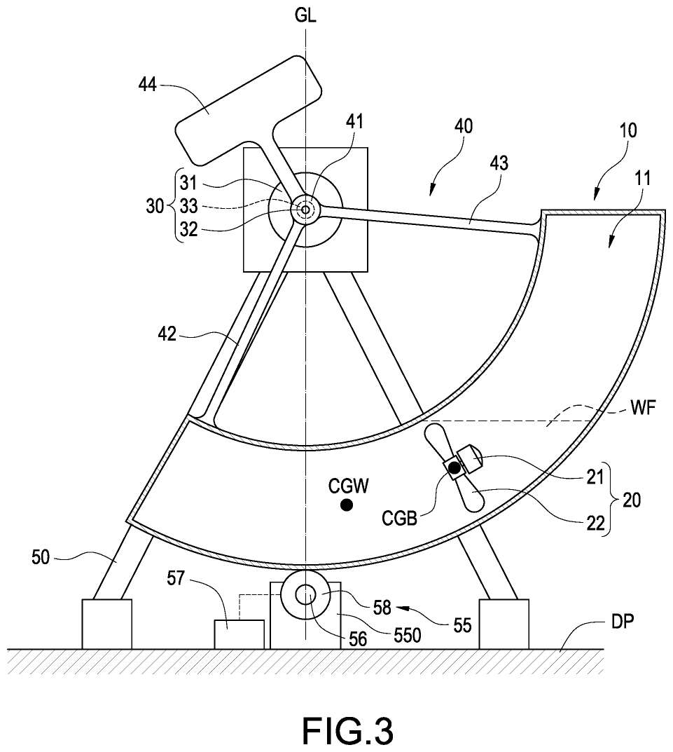

In FIGS. 2 and 3, the long box body 10 has a center of gravity CGB of the long box body, and the working fluid WF has a center of gravity CGW of the working fluid. A gravity line GL is defined in the direction of the plumb line through the shaft 32 of the pivot structure 30. During operation, when the left side of the long box body 10 is in the highest position, the working fluid WF is accumulated to the right side of the accommodating cavity 11, so that most of the working fluid WF is on the right side of the accommodating cavity 11, and the center of gravity CGW of the working fluid is shifted to the left side of the gravity line GL, and the center of gravity CGB of the long box body is also shifted to the left side of the gravity line GL. Thus, the torque is maximum and the centrifugal force is minimum at this time, and the torque makes the long box body 10 tend to rotate counterclockwise.

When the long box body 10 reaches its equilibrium position (as shown in FIG. 1), the center of gravity CGB of the long box body and the center of gravity CGW of the working fluid are situated on the gravity line GL, and the working fluid WF on two sides of the accommodating cavity 11 are equal to provide the minimum torque and the maximum rotation speed, so to the centrifugal force is maximum and the inertia of the rotation is maximum. At this time, the long box body 10 continues rotating counterclockwise.

After the working fluid WF continues to flow toward the left side of the accommodating cavity 11, the center of gravity CGB of the long box body and the center of gravity CGW of the working fluid keep moving toward the right side, until the right side of the long box body 10 is situated at the highest position, and then the working fluid WF is accumulated on the left side of the accommodating cavity 11, so that most of the working fluid WF is on the left side of the accommodating cavity 11, and the center of gravity CGB of the long box body and the center of gravity CGW of the working fluid are shifted to the right side of the gravity line GL. At this time, the torque is the maximum and the centrifugal force is minimum, and the torque makes the long box body 10 tend to rotate clockwise and keep oscillating over and over again.

According to the above operation, the long box body 10 swings to a higher position by applying a small force, which is much easier than lifting the same weight to the same height. With the action of torsion, centrifugal force, and inertia force, etc., the overall structure becomes a labor-saving machine, in which a difference between the height of the working fluid WF and the potential energy is generated by the difference of the working fluid WF to accelerate the flow of the working fluid WF to the other side. In this way, a part of the power generated by power generator 21 is supplied to the drive and control structure 55 to drive the long box body 10 to oscillate, and another part of the power is used for external power supply, resulting in an overall net output for sustainable power generation.

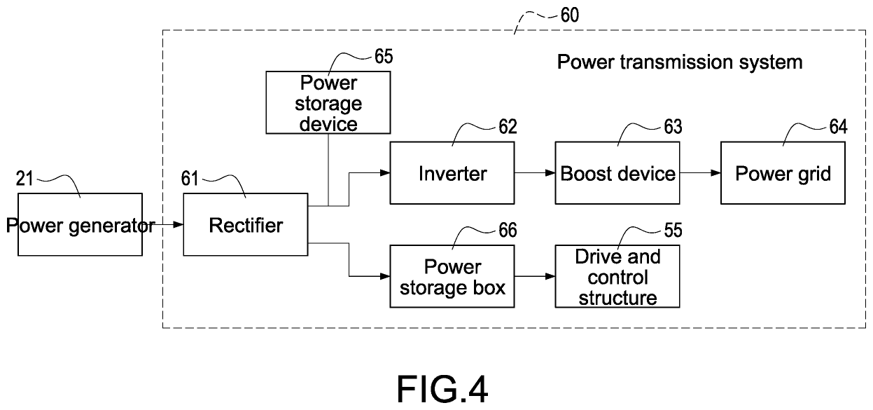

With reference to FIG. 4 for an imitated pirate ship type hydroelectric power generation device in accordance with an embodiment of the present disclosure, the imitated pirate ship type hydroelectric power generation device further includes a power transmission system 60, and the electric power generated by the power generator 21 of the hydro-turbine power generator unit 20 is electrically connected to the power transmission system 60 through a cable, and the current passing through the rectifier 61 is divided into two paths. One of the paths sequentially passes through an inverter 62 and the passes through a boost device 63 for boosting voltage and importing the electric power into a power grid 64, and there is an power storage device 65 installed between the rectifier 61 and the inverter 62 to achieve the effects of energy storage and voltage stabilization. The other one of the paths passes through a power storage box 66 first, and then connects to the drive and control structure 55, and the rotation direction and speed of the electric motor 56 and the roller 58 are adjusted by the controller 57 to control the oscillating angle and frequency of the long box body 10, so as to control the flow of the water and the amount of generated power.

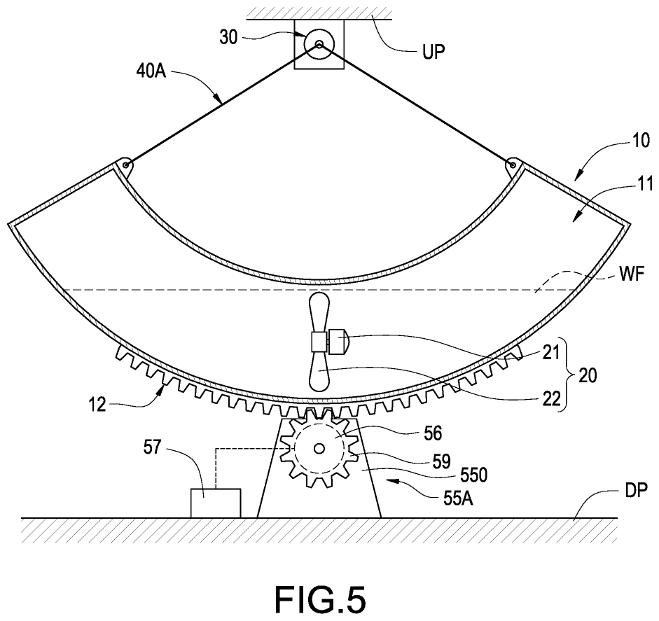

With reference to FIG. 5 for an imitated pirate ship type hydroelectric power generation device of the present disclosure, the imitated pirate ship type hydroelectric power generation device may also be in the form of this embodiment, in addition to the above embodiment. In this embodiment, the pivot structure 30 is installed on an upper platform UP, the connecting structure 40A is a steel rope with two ends respectively connected to the pivot structure 30 and the long box body 10, the lower surface of the long box body 10 is provided with a curved rack 12, and the drive and control structure 55A includes a gear 59 connected to the electric motor 56, wherein the gear 59 and the curved rack 12 are engaged and transmitted with each other. In this way, this embodiment has the same performance as the previous embodiment.

In summation of the description above, the imitated pirate ship type hydroelectric power generation device of the present disclosure achieves the intended purpose of use, overcomes the drawbacks of the related art.

What is claimed is:

1. An imitated pirate ship type hydroelectric power generation device, filled with a working fluid (WF) therein, the imitated pirate ship type hydroelectric power generation device comprising:
a long box body (10), comprising an accommodating cavity (11) providing the working fluid (WF) to be filled;
a hydro-turbine power generator unit (20), comprising an impeller (22) and a power generator (21) coupled to the impeller (22), and the impeller (22) installed in the accommodating cavity (11);
a pivot structure (30), installed on the long box body (10) and located at a middle portion of the long box body (10); and
a connecting structure (40), coupled to the pivot structure (30) and the long box body (10);
wherein, after a force is applied to the long box body (10), the long box body (10) swings pivotally by the pivot structure (30) as a rotation center, and the working fluid (WF) flows reciprocally in the accommodating cavity (11) and drive the impeller (22) to rotate to generate an electric power from the power generator (21).

2. The imitated pirate ship type hydroelectric power generation device according to claim 1, further comprising a drive and control structure (55) installed below the long box body (10) and slidably contacting the long box body (10).

3. The imitated pirate ship type hydroelectric power generation device according to claim 2, wherein the drive and control structure (55) comprises a fixed base (550), an electric motor (56), a controller (57) electrically coupled to the electric motor (56) and a roller (58) coupled to the electric motor (56), the electric motor (56) is installed on the fixed base (550) and drives the long box body (10) to swing through the roller (58), the controller (57) is configured to change a rotation direction and a speed of the electric motor (56), and the roller (58) slidably contacts the long box body (10).

4. The imitated pirate ship type hydroelectric power generation device according to claim 3, wherein the roller (58) is a rubber wheel.

5. The imitated pirate ship type hydroelectric power generation device according to claim 2, wherein the long box body (10) comprises a curved rack (12), the drive and control structure (55A) comprises an electric motor (56) and a gear (59) coupled to the electric motor (56), and the gear (59) and the curved rack (12) are engaged with each other for transmission.

6. The imitated pirate ship type hydroelectric power generation device according to claim 2, further comprising a power transmission system (60), and the electric power generated by the hydro-turbine power generator unit (20) being transmitted to the power transmission system (60) through a cable.

7. The imitated pirate ship type hydroelectric power generation device according to claim 6, wherein a current is divided into two paths after passing through a rectifier (61), one of the paths sequentially passes through an inverter (62) and then passes through a boost device (63) to boost a voltage, and the electric power is imported to a power grid (64); another one of the paths passes through a power storage box (66) and is connected to the drive and control structure (55, 55A).

8. The imitated pirate ship type hydroelectric power generation device according to claim 7, further comprising a power storage device (65) installed between the rectifier (61) and the inverter (62).

9. The imitated pirate ship type hydroelectric power generation device according to claim 1, wherein the pivot structure (30) comprises a shaft seat (31), a shaft (32) and a bearing (33), and the shaft (32) is coupled to the shaft seat (31) through the bearing (33).

10. The imitated pirate ship type hydroelectric power generation device according to claim 9, wherein the connecting structure (40) comprises a bushing (41) and a first link rod (42) and a second link rod (43) coupled to the bushing (41), the bushing (41) is coupled to the shaft (32), another end of the first link rod (42) is coupled to one end of the long box body (10), and another end of the second link rod (43) is coupled to another end of the long box body (10).

11. The imitated pirate ship type hydroelectric power generation device according to claim 10, wherein the connecting structure (40) further comprises a balance member (44) coupled to the bushing (41) and extended in a direction opposite to the first link rod (42) and the second link rod (43).

12. The imitated pirate ship type hydroelectric power generation device according to claim 11, further comprising a support structure (50) fixed to a lower platform (DP) by one end thereof and fixed with the pivot structure (30) by another end thereof.

13. The imitated pirate ship type hydroelectric power generation device according to claim 1, wherein the pivot structure (30) is installed on an upper platform (UP), the connecting structure (40A) is a steel rope, and the steel rope is coupled to the pivot structure (30) and two ends of the long box body (10).
